(19) United States
(12) Patent Application Publication
(10) Pub. No.: US 2013/0160063 A1
(43) Pub. Date: Jun. 20, 2013

(54) NETWORK DELIVERY OF BROADCAST MEDIA CONTENT STREAMS

(71) Applicant: Usman Rashid, Irvine, CA (US)

(72) Inventor: Usman Rashid, Irvine, CA (US)

(21) Appl. No.: 13/332,169

(22) Filed: Dec. 20, 2011

(51) Int. Cl. H04N 21/2343; H04N 21/233; H04N 21/231

(52) U.S. Cl. 725/109; 725/116

(57) ABSTRACT

The delivery of multimedia content is disclosed. An input stream of the multimedia content in a first predetermined format, and including encoded video data and audio data is received from a broadcaster server system. The input stream is converted to a second predetermined format, and split into an audio data stream and one or more video data streams. Segments of the audio data stream and the video data streams are generated, with each segment representing a predetermined number of time-sequenced signal samples and frames of the respective audio and video. Each of the generated segments of the audio data stream and the video data streams is transmitted to a data storage system.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

1. Technical Field

The present disclosure relates generally to multimedia data streaming systems and methods, and more particularly, to delivering television and other broadcast media content over data transmission networks to remote clients.

2. Related Art

The global Internet network is a popular medium for distributing a variety of multimedia content from its producers to the end consumers, and available content includes images, sound, and video, as well as text-based documents such as books and magazines. This is due in part to the widespread availability of computer systems with the sufficient processing power, storage capacity, and display capabilities to render multimedia content, as well as to the high speed network infrastructure of the Internet and associated network interface devices of the end-user computer system that make real-time streaming and rapid transfer possible, notwithstanding the data-intensive nature of such content. Additionally, advancements in video compression and the adoption of industry-wide video and audio encoding and container standards have facilitated Internet-based multimedia distribution.

Various markets and business models have developed in relation to the sale of multimedia content. In the context of traditional entertainment media, individual songs, movies, and television programs are sold or licensed as discrete products for a one-time download fee. For a lower price, access to the material may be time-limited as in a rental. Alternatively, unlimited access may be given for payment of a monthly subscription fee that may be tiered according to certain access limitations, and continued so long as the subscription is maintained. These forms of distribution and sales are the closest analogue to the more traditional sales models, and the aforementioned improvements in data transfer speeds and computing power eased the transition.

Largely prior to the acceptance of electronic distribution of music, motion pictures, and other multimedia by the major commercial producers, several content sharing websites were in existence. Among the currently most popular and well-known for video is YouTube, where amateurs and professionals alike produce movies of varying length that are uploaded for viewing by other users. Similar websites exist for other media, such as Flickr for photographs. Unfortunately for the commercial content producers, material that was alleged to infringe copyrights was also being shared. While much of the content on video sharing sites is produced by amateurs, commercial entities are increasingly contributing, subsidized in part by advertisements included in the video itself or displayed on the video sharing website. Such programming, also referred to as web television, is typically produced as a series and the individual shows relatively short compared to its broadcast television counterparts.

With specific regard to serial programs or shows, current forms of its electronic distribution is vastly different from traditional broadcasting of the same. Whereas the programs are distributed electronically as discrete units of product (files or other unitary representations) much like music and motion pictures, there generally is no like segregation with broadcast media. Instead, programming is segregated according to broadcast stations or channels, with each station broadcasting a continuous stream of programming. The various stations may produce their own content such as news programs and others of local interest, which may be supported with revenue from advertising aired together with the produced content. Such local stations are typically affiliates of nationwide broadcast companies that produce content that is syndicated to the local stations. Accordingly, as a viewer, the selection of available programming is limited to what is currently on-air among the various broadcasting stations/channels, rather than specific selectable content chosen by the viewer.

To a limited extent, individual local television stations simultaneously stream broadcasts to the Internet. Presently, each station maintains its own website, through which the broadcast streams are accessible. In order to view the stream, it is necessary for the viewer to navigate to the station website and retrieve the link for it. A viewer application external to the web browser then accesses the stream, and renders the content for display. Thus, the user must manage a potentially extensive bookmark list of television station websites for each stream of interest.

The available bandwidth of the local television stations for streaming are typically limited because there is only a need to serve the local population. However, there may occasionally be a demand for a particular television station stream that extends beyond its geographic locale thereof. For instance, there may be ongoing news coverage of a major event that generates nationwide or worldwide interest in which the local station provides earlier or more detailed coverage than its larger counterparts. This sudden surge in demand may negatively affect the viewing experience in the form of slower downloads, reduction in video quality, and the inability for some users to connect to the stream. Worse still, the entire video streaming system may grind to a halt, preventing any and all interested viewers from accessing the broadcast.

Current video streaming systems, particularly those utilized by television stations to stream its broadcast programming, often utilize the Flash Video format by default. As briefly mentioned above, raw video and audio data is compressed, encoded, and formatted for transmission to a client-side video playback application or plugin. Although widely deployed, due to various well-documented security flaws and other programming inefficiencies associated with the playback plugin, Flash Video is problematic. Some mobile device manufacturers have even refused to support Flash Video, so in some circumstances it may be desirable to eliminate its use.

Accordingly, there is a need in the art for improved network delivery of broadcast media content streams.

### BRIEF SUMMARY

In accordance with one embodiment of the present disclosure, a method for delivering multimedia content to client systems is contemplated. The method may begin with receiving an input stream of the multimedia content in a first predetermined format from a broadcaster server system. The input stream may include encoded video data and audio data time-sequenced into packets of one or more frames of video and signal samples of audio. Thereafter, the method may include converting the input stream of the multimedia content to a second predetermined format. There may also be a step of splitting the converted input stream of the multimedia content in the second predetermined format to an audio data stream and one or more video data streams. This may be followed by a step of generating segments of the audio data stream and the one or more video data streams. Each segment may represent a predetermined number of time-sequenced signal samples and frames of the respective audio and video. The method may further include transmitting each of the generated segments of the audio data stream and the one or more video data stream to a data storage system.

Another embodiment of the present disclosure contemplates a scalable multimedia content delivery system. The system may include a data storage system, as well as a plurality of independent virtual media servers each connectible to a specific broadcast source stream. Each of the virtual media servers may include a stream receiver module receptive to the specific broadcast source stream, as well as a stream splitter module connected to the stream receiver module. The stream splitter module may generate an audio stream and one or more video streams from the specific broadcast source stream. The virtual media server may further include a plurality of segmenter modules connected to the stream splitter module. The segmenter modules may correspond to each of the audio stream and the one or more video streams. Size-limited segments of the respective audio stream and the video streams may be generated by the respective segmenter modules. The virtual media server may also include a media uploader module linked to at least one of the segmenter modules and being in communication with the data storage system. The media upload or module may transmit the generated segments of the audio stream and the video streams to the data storage system. In addition to the foregoing, the scalable multimedia content delivery system may include a stream aggregation server with a multimedia content listing stored thereon. The multimedia content listing may have links to the segments of the audio stream and the segments of the video streams for each of the broadcast source streams.

In yet another embodiment of the present disclosure, a system for delivering media content from a broadcaster media server is contemplated. The system may include a stream receiver module in communication with the broadcaster media server. The stream receiver module may be receptive to the media content in a first predetermined format. There may also be a stream converter module having an input linked to the stream receiver module. The media content in the first predetermined format may be converted to a second predetermined format by the stream converter module. Additionally, the system may include a stream splitter module having an input linked to the stream converter module. The stream splitter module may generate an audio stream of encoded time-sequenced audio data and one or more video streams of encoded time-sequenced video data from the media content in the second predetermined format. Furthermore, there may be a plurality of segmenter modules linked to the stream splitter module. The segmenter modules may correspond to each of the audio stream and the one or more video streams. Size-limited segments of the respective audio stream and the video streams may be generated by the respective segmenter modules. The system may further include a media uploader module linked to at least one of the segmenter modules and may be in communication with a data storage system. The media uploader module may transmit the generated segments of the audio stream and the video streams to the data storage system.

The present invention will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which:

FIG. 1 is a block diagram illustrating one embodiment of a scalable multimedia content delivery system and its constituent components including a data storage system, a virtual media server, and a stream aggregation server in an exemplary environment;

FIG. 2 is a block diagram illustrating the details of a system for delivering media content, which in some embodiments also corresponds to the virtual media server of the scalable multimedia content delivery system shown in FIG. 1;

FIG. 3 is a flowchart showing one exemplary embodiment of a method for delivering multimedia content; and

FIGS. 4A-4C are example screen captures of a user interface to the stream aggregation server.

Common reference numerals are used throughout the drawings and the detailed description to indicate the same elements.

### DETAILED DESCRIPTION

The detailed description set forth below in connection with the appended drawings is intended as a description of the various embodiments of methods and systems for network delivery of broadcast media content streams and is not intended to represent the only forms that may be developed or utilized. The description sets forth the various functions in connection with the illustrated embodiments, but it is to be understood, however, that the same or equivalent functions may be accomplished by different embodiments that are also intended to be encompassed within the scope of the present disclosure. It is further understood that the use of relational terms such as first and second, and the like are used solely to distinguish one entity from another without necessarily requiring or implying any actual such relationship or order between such entities.

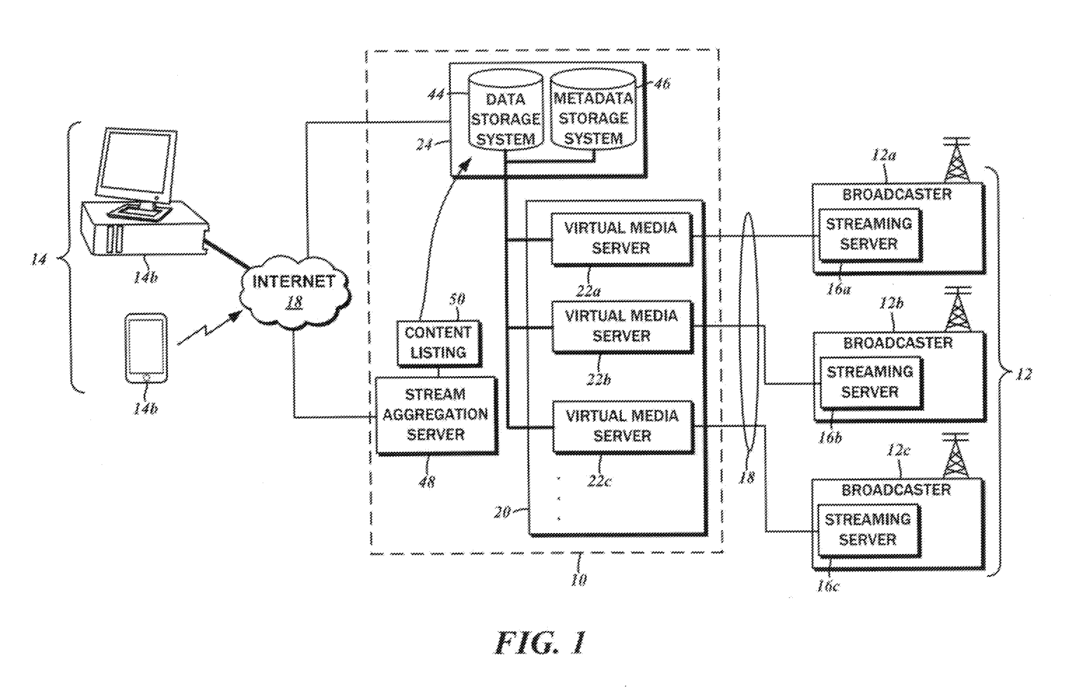

With reference to the block diagram of FIG. 1, one embodiment of a scalable multimedia content delivery system 10 will now be described. One of its contemplated features or functions is the aggregation and delivery of content from various television broadcast stations 12 to end user computing devices 14 over a data communications network. Although television content is conventionally delivered over terrestrial broadcasts and its reach is therefore geographically limited, the scalable multimedia content delivery system 10 is capable of communicating with television broadcast stations 12 in disparate geographic locations. Accordingly, a first television broadcast station 12a may be outside the geographical broadcast area of a second television broadcast station 12b, which may be further outside the geographical broadcast area of yet another third television broadcast station 12c. The scalable multimedia content delivery system 10 is described in relation to these three broadcast stations 12a-12c, but it will be appreciated by those having ordinary skill in the art that any number of additional broadcast stations 12 may be added and handled thereby. Along these lines, while the various features of the scalable multimedia content delivery system 10 relate to the processing of television content and its constituent video and audio signals, it will be recognized that any other multimedia content may be substituted. Indeed, the origin of the multimedia content need not be limited to television broadcast stations, and may be any other streaming multimedia source.

Each of broadcast station the television broadcast stations 12 is understood to have a corresponding streaming media server 16, that is, the first television broadcast station 12a has a first streaming media server 16a, the second television broadcast station 12b has a second streaming media server 16b, and the third television broadcast station 12c has a third streaming media server 16c. The streaming media servers 16 are each understood to be conventional computer systems having a central processing unit, memory, and input and output devices, as well as media conversion and encoding software.

Television or any other multimedia content, at is fundamental level, is comprised of an encoded sequence of images or frames of video information, together with encoded sound waves representative of the accompanying audio information. There are various industry standards that govern the specific way in which the video and audio information are captured, encoded, compressed, and reconstructed for output or display. For digital television, and specifically the ATSC (Advanced Television Systems Committee) standard utilized in the United States, the video information is encoded and compressed with an MPEG-2 (Motion Pictures Expert Group) Part 2/H.262 codec, while the audio information is encoded and compressed with the Dolby Digital AC-3 codec. This encoded video and audio data may be stored together according to a container format such as the MPEG transport stream under the MPEG-2 standard. The resultant data stream is then modulated with a radio frequency (RF) carrier signal for broadcast transmission.

Multimedia content distribution is not limited to broadcast digital television, and so the video and audio encoding and container formats currently in existence are likewise not limited to those discussed above, which are specific to the ATSC standard. Conventional personal computers have the capability to render multimedia content in a variety of container formats and encoding standards, so long as the appropriate playback software or plugins are installed. Because of the flexibility in being able to install any desired playback software or plugin, there is no one definitive standard for online multimedia content distribution.

One of the more popular and widely accepted video container format is Flash video, which utilizes the Sorenson Spark (variant of the H.263 standard), Screen video, On2 VP6 or H.264 video codecs, and the MP3 (MPEG-1, Layer 3), ADPCM (Adaptive Differentia Pulse Code Modulation), LPCM (Linear Pulse Code Modulation), AAC (Advanced Audio Coding) or other audio codecs. Thus, the streaming media servers 16 may encode and compress the raw video and audio information with the aforementioned codecs instead of utilizing the same encoded video and audio data intended for digital television broadcast when distributing content online with the Flash video format, or any other competing video format currently in existence. The streaming media servers 16 are configured to have sufficient data processing and Internet connectivity speeds to process the raw video and audio information for delivering multimedia content in real-time to its intended destination. Because of these contemplated functions, the streaming media server 16 may also be referred to as a broadcast source stream.

In a typical configuration, the scalable multimedia content delivery system 10 is connected to the individual broadcast stations 12a-12c, and specifically the respective streaming media servers 16a-16c thereof, indirectly via an intermediate wide area network 18. As indicated above, the broadcast stations 12 may be in geographically disparate locations, meaning that the scalable multimedia content delivery system 10 is likewise remote from at least one of the broadcast stations 12. The intermediate wide area network 18 may be the Internet in some embodiments, though other dedicated high-speed network links may be utilized.

One of the components of the scalable multimedia content delivery system 10 is a data processing platform 20 that includes a plurality of independent virtual media servers 22. Each of the virtual media servers 22 is dedicated to a specific broadcast station 12; that is, a first virtual media server 22a corresponds to the first television broadcast station 12a and connected to the first streaming media server 16a, a second virtual media server 22b corresponds to the second television broadcast station 12b and connected to the second streaming media server 16b, and a third virtual media server 22c corresponds to the third television broadcast station 12c and connected to the third streaming media server 16c. As discussed above, the scalable multimedia content delivery system 10 is expandable to process multimedia content streams from any number of broadcast stations 12, and so it is contemplated that the number of virtual media servers 22 is likewise expandable to accommodate the additional streaming media server 16. The number of virtual media servers 22 shown in FIG. 1 is by way of example only and not of limitation. It is also possible to connect one virtual media server 22 to more than one streaming media server 16, or to connect one streaming media server 16 to more than one virtual media server 22, depending upon the data processing capabilities and network connectivity speeds.

According to one embodiment of the present disclosure, the data processing platform 20 is the Elastic Compute Cloud (EC2) from Amazon.com. With EC2, it is possible to create an instance or a virtual machine to run any desired software, which, in the presently contemplated embodiment, is the collection of software modules, which are executed by and on hardware devices, envisioned to implement the functionality of the virtual media server 22. Thus, an instance or virtual machine may correspond to the independent virtual media server 22 as defined above. The most cost effective scaling of the multimedia content delivery system 10 may be achieved by utilizing a commercial data processing platform 20 such as the Amazon.com EC2 because of the ready availability of computing resources. The number of virtual media servers 22 dedicated to the scalable multimedia content delivery system 10 may be increased or decreased depending on demand, with payment for the data processing services being only to the extent of utilization. Although in some cases it is possible to set up dedicated hardware servers in place of the virtual media servers 22, a substantial initial outlay of capital may be necessary, and may result in substantial waste if the computing resources are not fully utilized.

The data processing platform 20 is connectible to a storage platform 24. In the embodiment where EC2 is utilized, the storage platform 24 is understood to be the Simple Storage System (S3), also from Amazon.com. It is understood that S3 is the storage counterpart to the data processing platform of EC2, and has similar scalability features. All types of data may be stored on the storage platform 24, and the specific content stored for the scalable multimedia content delivery system 10 will be described in further detail below. Again, notwithstanding the contemplated embodiment utilizing a commercially available cloud computing service, dedicated hardware servers with the same functionality may be substituted without departing from the scope of the present disclosure.

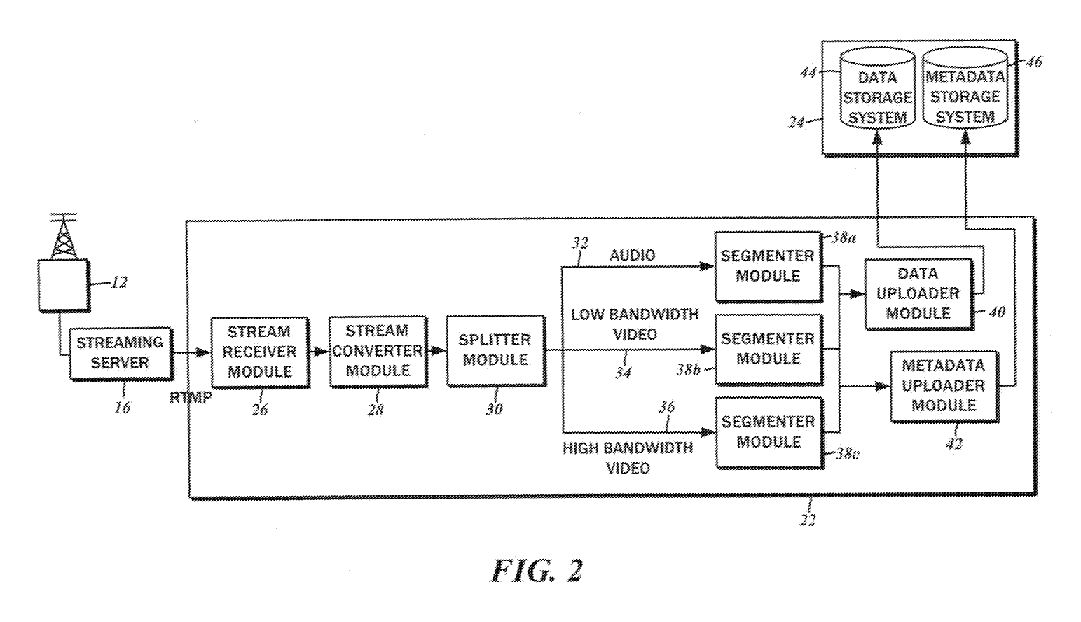

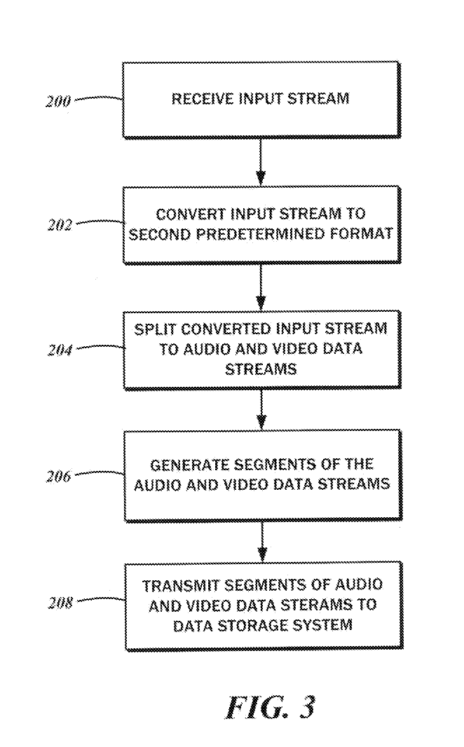

Having described some of the general features of the scalable multimedia content delivery system 10 and its connection to the broadcast stations 12, additional details regarding the core functionality of the virtual media server 22 will now be considered with reference to FIG. 2. As mentioned above, another embodiment of the present disclosure contemplates a method for delivering multimedia content, and the steps of such method and its relation to the component modules of the virtual media server 22 will be described with reference to the flowchart of FIG. 3.

The scalable multimedia content delivery system 10 is connected to the respective streaming media server 16 of the various broadcast stations 12, though the block diagram of FIG. 2 illustrates just one of those streaming media servers 16 connected to the one virtual media server 22. Certain details of the intermediate wide area network 18 have been omitted. The various components of the virtual media server 22 may be implemented as software modules executed on and by the data processing platform 20. Along these lines, the steps of the method for delivering multimedia content may constitute computer-executable instructions that are stored on a non-transitory computer readable medium.

In accordance with another embodiment of the present disclosure, the virtual media server 22 includes a stream receiver module 26 that is in communication with the streaming media server 16, also referred to as a broadcast media server. Relatedly, the method for delivering multimedia content begins with a step 200 of receiving the input stream of the multimedia content, a step that is achieved with the stream receiver module 26. The stream receiver module 26 is understood to be receptive to media content that is in a first predetermined format. The input stream includes encoded video data and audio data that are time-sequenced into packets of one or more frames of video and segments of audio.

As indicated above, the streaming media server 16 generates a multimedia content stream stored in the Flash video container format, which is understood to correspond to the first predetermined format. In embodiments where Flash video is utilized, the multimedia content stream is transmitted to the virtual media server 22 over RTMP (Real-Time Messaging Protocol), so the stream receiver module 26 may be an RTMP client software application. Different embodiments that use alternative content delivery standards are understood to have corresponding client software applications or implementations of the stream receiver module 26 that communicate with the streaming media server 16.

Following receipt of the multimedia content stream by the stream receiver module 26, the method continues with a step 202 of converting the same to a second predetermined format. For one exemplary embodiment, the second predetermined format is the MPEG-4, Part 14 container format. The conversion process may be achieved by a stream converter module 28, which may be implemented as a software application such as the freely available ffmpeg. Those having ordinary skill in the art will recognize that other multimedia conversion software applications may be substituted without departing from the scope of the present disclosure. It is contemplated that the stream receiver module 26 is separate from the stream converter module 28, in that the stream converter module 28 may be logically linked to the output of the stream receiver module 26. In other words, the step of receiving converting the multimedia content stream may be implemented as an executable script on the virtual media server 22 where the output of the software application of the stream receiver module 26 is passed to the input or execution parameters of the software application of the stream converter module 28. The various other functions implemented on the virtual media server 22 may be so similarly linked from one module to another.

The underlying video and audio information within the multimedia content stream in the first predetermined format, e.g., Flash video, is understood to be encoded and compressed according to any one of several industry standards as discussed above. The MPEG-4 standard likewise defines one of several acceptable audio and video encoding and compression modalities. With both Flash video and MPEG-4, there are several shared acceptable encoding and compression modalities, including H.264 for video information, and AAC for audio information, among others. To the extent the received multimedia content stream in the first predetermined format utilizes the same encoding and compression standards as the second predetermined format, all that is required of the conversion process may be to transfer the data to the different container format. However, where the encoding and compression techniques in the received multimedia content stream in the first predetermined format is not one that is shared with the second predetermined format, a conversion or decoding/re-encoding process may be utilized. Both such operations are performed by the stream converter module 28.

The method for delivering multimedia content may continue with a step 204 of splitting the converted multimedia content stream, which is in the second predetermined format, to an audio data stream and one or more video data streams. For this function, it is contemplated that the virtual media server 22 includes a splitter module 30, with an input thereof being connected or otherwise logically linked to the output of the stream converter module 28. In the exemplary embodiment shown, there is an audio data stream 32, a first or low bandwidth video stream 34, and a second or high bandwidth video stream 36. As will be described in further detail below, the high-bandwidth stream 36 is intended for transmission to the end user computing devices 14 over network links capable of high data transfer speeds, while the low bandwidth video data stream 34 is intended for transmission over lower speed network data links that may be of lower quality or fidelity as a result of decreased data requirements.

The individual video data streams 34, 36 and the audio data stream 32 are passed to an audio segmenter module 38a, a low bandwidth video segmenter module 38b, and a high bandwidth video segmenter module 38c, respectively. Preferably, though optionally, there are separate instances of the segmenter modules 38 for each data stream from the splitter module 30. Again, the segmenter modules 38 are understood to be a software application programmed to execute the functions as described in greater detail below.

The segmenter modules 38 are understood to generate separable, though time-sequenced groupings of streaming data. For instance, the low bandwidth video segmenter module 38b generates data units comprised of a predetermined number of sequential frames of the low bandwidth video data stream 34. Further, the high-bandwidth video segmenter module 38c generates another set of data units comprised of a predetermined number of sequential frames of the high-bandwidth video data stream 36. The number of predetermined frames in a given segment is understood to be the same, whether it is the low bandwidth video data stream 34 or the high-bandwidth video data stream 36. As such, each video segment can also be considered a certain time range of frames within the overall video stream.

With respect to audio data, although not referred to as frames, it is similarly comprised of time-sequenced data, except that the data represents an audio waveform, with any given point in the signal being referred to as a signal sample. Therefore, a segment of the audio data stream 32 is comprised of a set of a predetermined number of sequential samples of the audio waveform. Each segment of the audio data stream 32 matches in length (time) and beginning and end points (times) as its corresponding segment of the low bandwidth video data stream 34 and the high-bandwidth video data stream 36.

The method for delivering multimedia content continues with a step 206 of generating segments of the audio data stream 32, the low bandwidth video data stream 34, and the high-bandwidth video data stream 36, as defined above. So that the individual segments may be reconstructed during playback, each of the segmenter modules 38 generate metadata that define the time and said sequence order for a given segment, whether the data therein constitutes audio data, low bandwidth video data or high-bandwidth video data. Additionally, metadata that may have been included in the input stream as part of a field in the first predetermined (container) format such as name or overall duration, may also be part of the metadata generated for each individual segment.

The generated segments of the audio data stream 32, the low bandwidth video data stream 34, and the high-bandwidth video data stream 36 are then passed to a segment uploader module 40. Similarly, the generated metadata are passed to a metadata uploader module 42. In accordance with an embodiment of the present disclosure, the method for delivering multimedia content includes a step 208 of transmitting the generated segments of the audio data stream 32 and the video data streams 34, 36 to a data storage system 44 that is implemented on the storage platform 24 discussed above. With the metadata being passed to the metadata uploader module 42, there is also contemplated step of transmitting the metadata to a metadata storage system 46 also implemented on the storage platform 24. Although it is possible for the data storage system 44 and the metadata stored system 46 to be part of a single standalone stored server, in the illustrated embodiment, they are separate and independent.

Referring back to the block diagram of FIG. 1, the data storage system 44 and the metadata storage system 46 are connected to another intermediate wide area network 18 such as the Internet. In embodiments of the scalable multimedia content delivery system 10 that utilize the cloud computing platform from Amazon.com, the data transmission services may be provided by the CloudFront server application. The end user computing devices 14 likewise connect to the intermediate wide area network 18 in order to retrieve the multimedia content as converted and segmented in the manner described above and transferred to the storage platform 24. The associated transmission and processing time may introduce a delay of around thirty seconds from the moment of on-the-air broadcast by the broadcast stations 12 and the moment the content is viewed by the end user computing devices 14.

There is a first end user computing device 14a, which may be a conventional desktop or other general-purpose computer system with a high-speed Internet connection 47. Whether directly selected by the end user, or automatically selected based upon an evaluation of the network speed using various techniques known in the art, where it is determined that the first network connection 47 can handle the additional data, the high bandwidth video data stream 36 is transmitted to the first end user computing device 14a upon a general request therefrom.

In another example, there is a second end user computing device 14b, which may be a mobile computing device such as a smart phone. Due to the phased deployment of mobile data communications technologies, some locales may have a second network connection 49 with a first predefined network transmission speed, while the second network connection 49 in other locales may have a second, faster predefined network transmission speed. The second end user computing device 14b may be capable of data communications are both the first (slower) predefined network transmission speed and the second (faster) predefined network transmission speed, but switching to different modes as required according to network coverage availability. When utilizing the first (slower) predefined network transmission speed, whether directly selected by the end user, or automatically selected based upon an evaluation of the network speed, the low bandwidth video data stream is transmitted to the second end user computing device 14b upon a general request therefrom. Under some circumstances, when the network connection is extremely poor, an audio-only version of the stream may be selected.

The specific mention of the conventional general-purpose computer system that is the first end user computing device 14a, and the mobile phone that is the second end user computing device 14b is by way of example only and not of limitation. Other devices capable of connecting to the scalable multimedia content delivery system 10 via the intermediate wide area network 18 such as set-top television boxes, gaming consoles, and so forth are also contemplated. Those having ordinary skill in the art will readily appreciate such alternative end user computing devices 14 with which the scalable multimedia content delivery system 10 may be utilized.

With the capability to store earlier broadcast multimedia content from the broadcast stations 12 on the storage platform 24, it is also possible to retain the audio and video segment data for later downloading and viewing, akin to a conventional digital video recorder. The user experience may be further enhanced with additional content beyond television broadcast and can also include pre-generated content such as movies, shows, and the like.

The audio and video segment data on the data storage system 44 may not be organized beyond that required by the file system or not at all, in that keyword searches, indexes, categories and other organizational aids for easier access by the end user computing devices 14 are not implemented thereon. Accordingly, there is contemplated a stream aggregation server 48 that includes a multimedia content listing 50 retrievable by the end user computing devices 14. Generally, the multimedia content listing 50 includes links to the segments of the audio stream and the segments of the video streams for each of broadcast stations 12 that are handled by the respective virtual media servers 22. Further levels of organization may be possible based upon the metadata associated with each of the data segments. The details of the individual segments may be abstracted out for purposes of usability, and may be simplified to the extent of accessing a particular stream, rather than the individual audio and video segments.

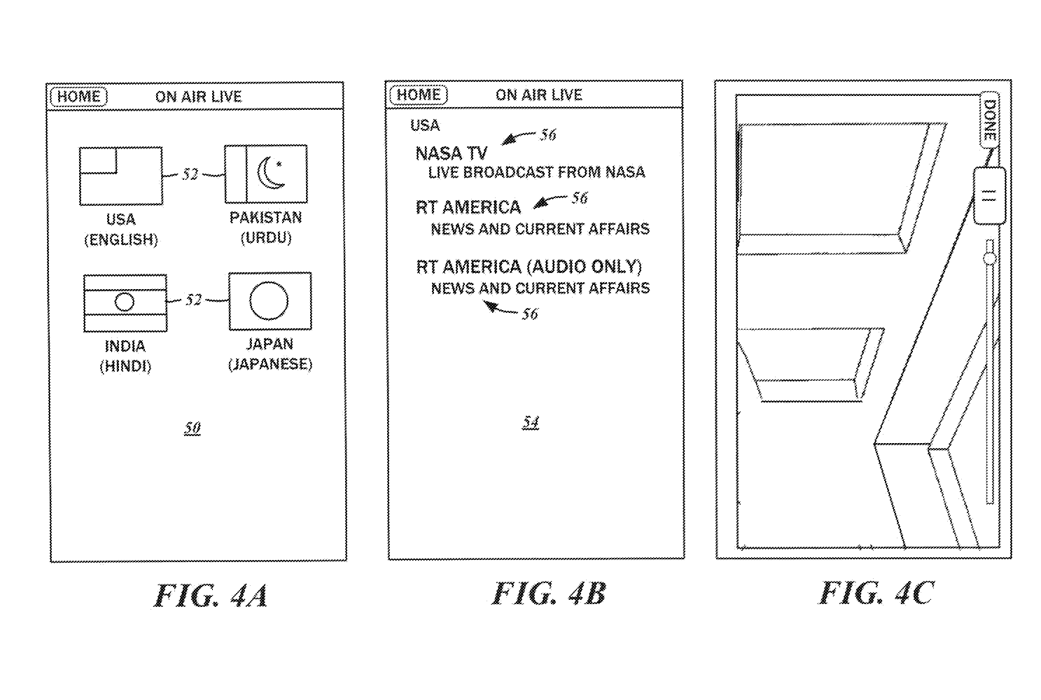

An example implementation of the multimedia content listing 50 as generated on the end user computing device 14 are shown in FIGS. 4A, 4B, and 4C. At the initial level shown in FIG. 4A, a listing 50 of first available categories, that is, the countries of origin of the broadcast stations 12 is shown, represented by the their respective flags in icons 52. Selecting the United States of America, for example, initiates the rendering of another listing 54 of the individual broadcast stations 12 available for viewing. The listings 54 may include a title associated with the particular multimedia content source, along with the detailed description thereof. This information may be displayed in a selectable link 56. Upon selection, as shown in FIG. 4C, the presentation of the multimedia content may begin.

The particulars shown herein are by way of example only for purposes of illustrative discussion, and are not presented in the cause of providing what is believed to be most useful and readily understood description of the principles and conceptual aspects of the various embodiments a fourth of the present disclosure. In this regard, no attempt is made to show any more detail than is necessary for a fundamental understanding of the different features of the various embodiments, the description taken with the drawings making apparent to those skilled in the art how these may be implemented in practice.

What is claimed is:

1. A method for delivering multimedia content to client systems, the method comprising:
receiving an input stream of the multimedia content in a first predetermined format from a broadcaster server system, the input stream including encoded video data and audio data time-sequenced into packets of one or more frames of video and signal samples of audio;
converting the input stream of the multimedia content to a second predetermined format;
splitting the converted input stream of the multimedia content in the second predetermined format to an audio data stream and one or more video data streams;
generating segments of the audio data stream and the one or more video data streams, each segment representing a predetermined number of time-sequenced frames and signal samples of the respective video and audio; and
transmitting each of the generated segments of the audio data stream and the one or more video data stream to a data storage system.

2. The method of claim 1, wherein the data storage system transmits the stored segments of the audio data stream and the one or more video data streams to a one of the client systems in response to a request therefrom.

3. The method of claim 1, wherein the input stream further includes media content metadata linked thereto.

4. The method of claim 3, further comprising:
generating segment metadata elements from the media content metadata linked to the input stream for at least one of the generated segments of the audio data stream and the one or more video data streams; and
transmitting the generated segment metadata to a metadata storage system.

5. The method of claim 4 wherein the metadata storage system transmits the stored segment metadata elements to a one of the client systems.

6. The method of claim 5, wherein each segment metadata field is associated with a specific one of the segments of the audio data stream and the one or more video data streams.

7. The method of claim 6, further comprising:
transmitting links to the segments of the audio data stream and the one or more video data streams to a stream aggregation server accessible by the client system; and
transmitting at least one of the stored segment metadata elements to the stream aggregation server.

8. The method of claim 7, wherein the links to the segments of the audio data stream and the one or more video data streams are stored in a multimedia content listing stored on the stream aggregation server and retrievable therefrom by the client system, the multimedia content listing being indexed according to the at least one of the segment metadata elements.

9. The method of claim 3, wherein the metadata includes a name field and a duration field.

10. The method of claim 1, wherein the one or more video data streams includes a low bandwidth video data stream and a high bandwidth video data stream.

11. The method of claim 10, wherein the segments of the low bandwidth video data stream are transmitted to the client system in a first predefined network transmission speed, and the segments of the high bandwidth video data stream are transmitted to the client system in a second predefined network transmission speed.

12. The method of claim 11, wherein the client system is a mobile telephone device having a first data reception mode corresponding to the first predefined network speed and a second data reception mode corresponding to the second predefined network speed.

13. The method of claim 1, wherein the input stream of the multimedia content corresponds to a channel of a broadcast station associated with the broadcaster server system.

14. The method of claim 13, wherein the broadcast station is a television station.

15. A system for delivering media content from a remote broadcaster media server, comprising:
a stream receiver module in communication with the broadcaster media server and receptive to the media content in a first predetermined format;
a stream converter module having an input linked to the stream receiver module, the media content in the first predetermined format being converted to a second predetermined format by the stream converter module;
a stream splitter module having an input linked to the stream converter module, an audio stream of encoded time-sequenced audio data and one or more video streams of encoded time-sequenced video data being generated from the media content in the second predetermined format thereby;
a plurality of segmenter modules linked to the stream splitter module, the segmenter modules corresponding to each of the audio stream and the one or more video streams, size-limited segments of the respective audio stream and the video streams being generated by the respective segmenter modules; and
a media uploader module linked to at least one of the segmenter modules and being in communication with a data storage system, the generated segments of the audio stream and the video streams being transmitted to the data storage system by the media uploader module.

16. The system of claim 15, wherein the media content corresponds to a first broadcast television channel.

17. The system of claim 15, wherein the plurality of segmenter modules generate segment metadata associated with one or more of the audio stream segments and video stream segments from metadata stored in the media content.

18. The system of claim 17, wherein the media uploader module transmits the segment metadata to a metadata storage system.

19. The system of claim 18, wherein the data store system and the metadata storage system are independent of each other.

20. The system of claim 15, wherein:
the one or more video streams include a high bandwidth stream and a low bandwidth stream; and
a first one of the plurality of segmenter modules corresponds the low bandwidth stream, and a second one of the plurality of segmenter modules corresponds to the high bandwidth stream.

21. The system of claim 15, further comprising:
a stream aggregation server with a multimedia content listing stored thereon, the multimedia content listing including links to the segments of the audio stream and the segments of the video streams.

22. A scalable web-based multimedia content delivery system, comprising:
a data storage system;
a plurality of independent virtual media servers each connectible to a specific broadcast source stream and including:
a stream receiver module receptive to the specific broadcast source stream;
a stream splitter module connected to the stream receiver module, an audio stream and one or more video streams being generated from the specific broadcast source stream by the stream splitter module;
a plurality of segmenter modules connected to the stream splitter module, the segmenter modules corresponding to each of the audio stream and the one or more video streams, size-limited segments of the respective audio stream and the video streams being generated by the respective segmenter modules; and
a media uploader module linked to at least one of the segmenter modules and being in communication with the data storage system, the generated segments of the audio stream and the video streams being transmitted to the data storage system by the media uploader module;
a stream aggregation server with a multimedia content listing stored thereon, the multimedia content listing including links to the segments of the audio stream and the segments of the video streams for each of the broadcast source streams.

23. The system of claim 22, wherein the broadcast source stream is in first predetermined format, each of the virtual media servers including:
a stream converter module connected to the stream receiver module, the broadcast source stream in the first predetermined format being converted to a second predetermined format different from the first predetermined format thereby for output to the stream splitter module.

24. The system of claim 22, further comprising:
a metadata storage system;
wherein the plurality of segmenter modules of the respective virtual media servers generate segment metadata associated with one or more of the audio stream segments and video stream segments from metadata stored in the broadcast source stream.

25. The system of claim 24, wherein the media uploader module of the respective virtual media servers transmits the segment metadata to the metadata storage system.

26. The system of claim 22, wherein each of the virtual media servers is deployed on an independent computer system core.

27. A non-transitory computer readable medium having computer-executable instructions for performing a method for delivering multimedia content to client systems, the method comprising:
receiving an input stream of the multimedia content in a first predetermined format from a broadcaster server system, the input stream including encoded video data and audio data time-sequenced into packets of one or more frames of video and signal samples of audio;
converting the input stream of the multimedia content to a second predetermined format;
splitting the converted input stream of the multimedia content in the second predetermined format to an audio data stream and one or more video data streams;
generating segments of the audio data stream and the one or more video data streams, each segment representing a predetermined number of time-sequenced frames and signal samples of the respective video and audio; and
transmitting each of the generated segments of the audio data stream and the one or more video data stream to a data storage system.

28. The computer-readable medium of claim 27, wherein the input stream further includes media content metadata linked thereto.

29. The method of claim 28, wherein the method for delivering multimedia content to client systems further includes:
generating segment metadata elements from the media content metadata linked to the input stream for at least one of the generated segments of the audio data stream and the one or more video data streams; and
transmitting the generated segment metadata to a metadata storage system.
